(19) United States
(12) Patent Application Publication
(10) Pub. No.: US 2025/0196148 A1
(43) Pub. Date: Jun. 19, 2025

(54) THERMAL SYSTEMS AND METHODS FOR FLOW CELLS, OTHER ANALYTIC SUBSTRATES, AND OTHER MICROFLUIDIC DEVICES

(71) Applicant: MGI Tech Co., Ltd., Shenzhen (CN)

(72) Inventors: Hao Xu, San Jose, CA (US); Jon Bartman, San Jose, CA (US); Yakov Bobrov, Burlingame, CA (US)

(21) Appl. No.: 18/965,041

(22) Filed: Dec. 2, 2024

Related U.S. Application Data
(60) Provisional application No. 63/611,974, filed on Dec. 19, 2023.

(51) Int. Cl. B01L 7/00; B01L 3/00

(52) U.S. Cl. CPC B01L 7/52; B01L 3/502715; B01L 3/502792; B01L 2200/0647; B01L 2200/16; B01L 2300/0645; B01L 2300/1872; B01L 2300/1894; B01L 2400/0427

(57) ABSTRACT

Thermal systems and methods including cooling and heating fixtures for use with flow cells and other analytic substrates. The cooling fixture includes a turbulent air flow cavity with an array of air flow diverters that facilitates fast, accurate, and uniform cooling of a flow cell or other substrate positioned across an opening of the cavity. The heating fixture includes an array of light emitting diodes that are spaced apart from and configured to provide overlapping radiation intensity profiles that facilitate fast, accurate, and uniform heating of the flow cell or other substrate positioned relative to the LED array.

### RELATED APPLICATIONS

This application claims benefit of priority to U.S. Provisional Application No. 63/611,974, filed Dec. 19, 2023, the entire content of which is incorporated herein by reference for all purposes.

### BACKGROUND

High-throughput nucleic acid sequencing technologies allow sequencing of millions or billions of nucleic acid templates in parallel.

There are many approaches to nucleic acid (e.g., DNA) sequencing. See, e.g., Kumar, K., 2019, “Next-Generation Sequencing and Emerging Technologies,” Semin Thromb Hemost 45 (07): 661-673. The most popular methods use flow cells with a large number of nucleic acid templates (e.g., 100 million to 1 billion or more) bound to an array of discrete binding sites patterned on an interior surface or surfaces of the flow cell. Generally, each site contains a clonal population of template sequences, such as a DNA nanoball (Complete Genomics, Inc.) or PCR products or amplicons (Illumina, Inc.).

In these approaches nucleic acid sequences are determined one base at a time over a series of sequencing “cycles.” Each cycle comprises (i) introducing reagents to each site on the array of immobilized template molecules; (ii) carrying out a series of biochemical or enzymatic reactions (“sequencing reactions”) simultaneously at the sites; (iii) detecting signals at each site (zero, one or more than one signal per site per cycle) by imaging the flow cell; and (iv) carrying out enzymatic, washing, or regeneration steps at each site on the array so that another sequencing cycle can be carried out. Without limitation the “signals” collected in (iii) may be optical signals, e.g., fluorescence or luminescence signals.

An example sequencing cycle includes a sequencing-by-synthesis process. In this approach, nucleotides are incorporated into a primer extension product (e.g. using reversible terminator nucleotides). In this approach, nucleotides can be labeled with, for example, a fluorescent dye or a source of a luminescence signal (e.g. luciferase or luciferase substrate). A luminescent signal includes chemiluminescence and bioluminescence. A nucleotide can be labeled directly with a fluorescent dye or a source of a luminescence signal or can be associated with an antibody, aptamer or other agent labeled with a signal generating moiety. In the process of sequencing a defined optical signal is produced at each site in an array by, for example, illumination of the fluorescent dye(s) with an excitation wavelength, and the signals and corresponding positions are recorded.

The different steps of a sequencing cycle require different temperatures in the flow cell's reaction space for optimal performance. Sequencing runs can involve hundreds or thousands of sequencing cycles, which means that the temperature in the flow cell reaction space will need to be altered hundreds or thousands of times over the course of the sequencing run. The speed, precision, and uniformity of temperature control in the reaction space affects cost, efficiency, and sequencing data quality. Temperatures need to ramp quickly for optimal processing time and achieving high throughput. Setpoint temperatures need to be highly uniform throughout the reaction space so that sequencing reactions can be done with high repeatability to provide high data quality. Current temperature control technologies do not allow for sufficiently fast, precise, and uniform control, particularly for large area flow cells. Current temperature control technologies leave much room for improvement.

Although the following discussion is framed in the context of nucleic acid sequencing, it will be recognized that the systems and methods disclosed herein are not limited to nucleic acid sequencing uses. The thermal systems and methods described herein may be used, for example, for nucleic acid analysis other than sequencing (e.g., SNP analysis, real time PCR analysis) or for analysis of chemical or biochemical processes using analytes other than nucleic acids. Although the following discussion is framed in the context of thermal systems used in connection with flow cells, it will be recognized that the systems and methods disclosed herein could also be used with other types of microfluidic devices. In some implementations, the thermal systems and methods described herein may be used, for example, with droplet manipulation devices using electrowetting.

### SUMMARY

In one example a microfluidic device thermal system includes: (a) a microfluidic device comprising a first member and a second member spaced apart from the first member to define a fluidic passage between the first and second members; and (b) a cooling fixture configured to reduce the temperature in the fluidic passage, the cooling fixture comprising a turbulent air flow cavity, a plurality of air flow diverters in the cavity, and an opening, wherein the first member of the microfluidic device extends across and covers the opening.

In this example the microfluidic device thermal system may further include a heating fixture configured to raise the temperature in the fluidic passage, the heating fixture having an array of light emitting diodes configured to emit infra-red light incident on the second member of the microfluidic device. The system may be configured to cycle the temperature of the fluidic passage through a plurality of states including at least one cooled state and at least one heated state.

In this example the microfluidic device may include a flow cell, the flow cell defining an analyte reaction space in the fluidic passage. The first member may include an array of nucleic acid template binding sites in the reaction space.

In this example the reaction space in the fluidic passage may have an area of at least 70 cm².

In this example the cooling fixture may further include a centrally located boss that extends upwards from the cavity floor. The air inlet may include a plurality of air inlets located in one or more sidewalls of the boss.

In this example the boss may have a top side including: (i) a fluidic connection for introducing a fluid into the fluidic passage of the flow cell, and (ii) a vacuum chamber for retaining the flow cell on the cooling fixture by vacuum negative pressure.

In this example cooled air may be supplied to the turbulent air flow cavity by a vortex tube.

In this example the vortex tube may have a compressed air inlet, a stationary vortex generator, a hot air exhaust, and a cool air exhaust. The cool air exhaust may be in fluid communication with the turbulent air flow cavity.

In this example operation of the vortex tube to supply cool air to the turbulent air flow cavity may reduce an average temperature in the fluidic passage by at least 15 degrees Celsius in less than 45 seconds.

In this example operation of the vortex tube to supply cool air to the turbulent air flow cavity may reduce an average temperature in the fluidic passage by at least 25 degrees Celsius in less than 30 seconds.

In this example when the fluidic passage is in the cooled state, the temperature across the fluidic passage may vary by less than 2 degrees Celsius.

In this example, when the fluidic passage is in the cooled state, the temperature across the fluidic passage may vary by less than 1.5 degrees Celsius.

In this example the array of light emitting diodes may be numerous light emitting diodes configured to emit overlapping infra-red light beams incident on the second member.

In this example the light emitting diodes may be spaced apart from one another and spaced away from the flow cell such that radiation profiles of adjacent light emitting diodes overlap.

In this example operation of the array of light emitting diodes may raise an average temperature of the fluidic passage by at least 15 degrees Celsius in less than 45 seconds.

In this example operation of the array of light emitting diodes may raise an average temperature of the fluidic passage by at least 25 degrees Celsius in less than 30 seconds.

In this example, when the fluidic passage is in the heated state, the temperature across the fluidic passage may vary by less than 2 degrees Celsius.

In this example, when the fluidic passage is in the heated state, the temperature across the reaction space may vary by less than 1.5 degrees Celsius.

In another example a thermal system for a microfluidic substrate may include a cooling fixture configured to reduce the temperature of the microfluidic substrate, the cooling fixture having a turbulent air flow cavity, several air flow diverters in the cavity, and an opening. The microfluidic substrate may extend across and cover the opening.

In this example the thermal system may further include a heating fixture configured to raise the temperature of the microfluidic substrate. The heating fixture may include an array of light emitting diodes configured to emit infra-red light incident on the microfluidic substrate. The system may be configured to cycle the temperature of the microfluidic substrate through a plurality of states including at least one cooled state and at least one heated state.

In this example the microfluidic substrate may have an area of at least 150 cm².

In this example the cooling fixture may further include an air inlet in fluid communication with the turbulent air flow cavity and an air exhaust in fluid communication with the turbulent air flow cavity. During operation of the cooling fixture cooled air may enter the turbulent air flow cavity through the air inlet, flow in a turbulent fashion past the air diverters, and exhaust through the air exhaust.

In this example cooled air may be supplied to the turbulent air flow cavity by a vortex tube.

In this example when the microfluidic substrate is in the cooled state, the temperature across the microfluidic substrate may vary by less than 2 degrees Celsius.

In this example the array of light emitting diodes may include light emitting diodes configured to emit overlapping infra-red light beams incident on the microfluidic substrate.

In this example the light emitting diodes may be spaced apart from one another and spaced away from the microfluidic substrate such that radiation profiles of adjacent light emitting diodes overlap.

In this example, when the microfluidic substrate is in the heated state, the temperature across the microfluidic substrate may vary by less than 2 degrees Celsius.

In this example the microfluidic substrate may be a flow cell including a first member and a second member spaced apart from the first member to define a fluidic passage between the first and second members. The flow cell may define an analyte reaction space in the fluidic passage.

In this example the microfluidic substrate may be an electrowetting substrate including an insulating layer and array of droplet manipulating electrodes.

In another example a thermal cycling method may include positioning a flow cell between a heating fixture and a cooling fixture of a thermal system. The flow cell may include a first member and a second member spaced apart from the first member to define a fluidic passage between the first and second members. The flow cell may define an analyte reaction space in the fluidic passage. The heating fixture may include an array of light emitting diodes configured to emit infra-red light incident on the second member of the flow cell. The cooling fixture may include a turbulent air flow cavity, several air flow diverters in the cavity, and an opening. The first member of the flow cell may extend across and cover the opening when the flow cell is positioned between the heating and cooling fixtures. In this example additional steps in the method may include: flowing a reagent into the reaction space and operating the heating fixture to raise a temperature of the reaction space to a heated state; maintaining the heated state for an incubation period; after the incubation period, flowing another reagent into the reaction space and operating the cooling fixture to lower the temperature of the reaction space to a cooled state; repositioning the flow cell to an imaging station and imaging the flow cell; and after imaging the flow cell, repositioning the flow cell between the heating and cooling fixtures.

### BRIEF DESCRIPTION OF FIGURES

FIG. 1 shows an example of a nucleic acid sequencing system including a flow cell, a cooling fixture, and a heating fixture.

FIG. 2 shows the cooling fixture of FIG. 1 removed from the flow cell and heating fixture.

FIG. 3 shows an example of a vortex tube.

FIG. 4 shows another example of a nucleic acid sequencing system, shown in an exploded view.

FIG. 5 shows the cooling fixture of the system of FIG. 4 in more detail, showing the topside.

FIG. 6 shows the cooling fixture of the system of FIG. 4 in more detail, showing the bottom side.

FIG. 7 shows the heating fixture of the system of FIG. 4 in more detail, showing the bottom side.

FIG. 8 illustrates an example of overlapping beam profiles associated with LED's of a heating fixture.

FIG. 9 illustrates a method of nucleic acid sequencing.

FIGS. 10-12 illustrate a temperature uniformity test of example cooling and heating fixtures of a nucleic acid sequencing system.

FIGS. 13-15 illustrate another temperature uniformity test of example cooling and heating fixtures of a nucleic acid sequencing system.

FIGS. 16-25 illustrate another temperature uniformity test of example cooling and heating fixtures of a nucleic acid sequencing system.

FIG. 26 illustrates an example of an electrowetting-on-dielectric device for manipulating droplets.

FIG. 27 shows the electrowetting-on-dielectric device of FIG. 26 in conjunction with examples of cooling and heating fixtures.

### DETAILED DESCRIPTION

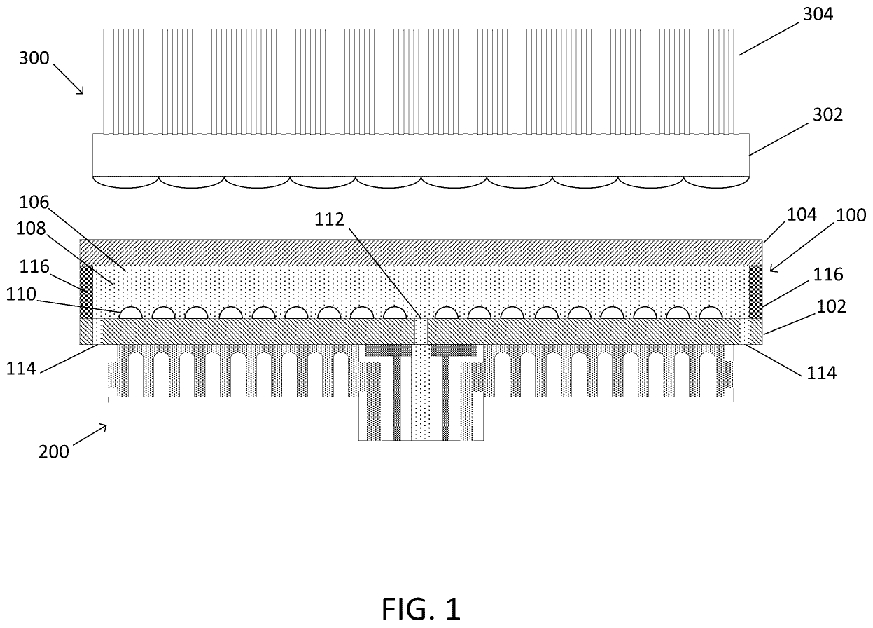

FIG. 1 shows an example of a thermal system for facilitating a nucleic acid sequencing process in a flow cell 100. The thermal system includes a cooling fixture 200 configured to reduce the temperature in a reaction space of the flow cell 100 and a heating fixture 300 configured to raise the temperature in the reaction space of the flow cell 100. The thermal system is configured to cycle the temperature in the reaction space through multiple states including at least one cooled state and at least one heated state.

### Flow Cell

The flow cell 100 of FIG. 1 includes a first member 102 and a second member 104 spaced apart from the first member 102 to define a fluidic passage 106 between the first and second members 102, 104. The flow cell 100 defines a reaction space 108 in the fluidic passage 106, which in this example is the space where nucleic acid templates 110 are bound in an array on first member 102. In other implementations, nucleic acid templates may be bound to both the first and second members 102, 104 or otherwise arranged in the flow cell 100.

The nucleic acid templates 110 may be DNA, RNA, or other nucleic acid material to be sequenced. In one specific example the nucleic acid templates may be DNA nanoballs arranged in a spaced array of discrete units across the inner surface of first member 102. Although not shown in the figures, the first member may include an array of discrete attachment sites spaced apart from one another where individual nucleic acid templates 110 may be held spaced apart from adjacent nucleic acid templates 110. Although only a few discrete templates 110 are shown in the figures for illustrative purposes, it should be understood that the such arrays may include up to millions or billions of discrete analyte sies, spaced at pitches that may be on the order of tens or hundreds of nanometers.

Flow cell 100 is configured for reagents and other fluids to be flowed through fluidic passage 106 to perform sequencing or other reactions on the templates 110. Fluids may be introduced into fluidic passage 106 via inlet 112 and removed via outlets 114.

In this example, the nucleic acid templates 110 on the interior surfaces of first member 102 (e.g. DNA nanoballs or other discrete nucleic acid analytes) are bound to discrete sites arranged in arrays on the interior surfaces of the member 102. These binding sites may be fabricated by well-known lithography tools, such as 248-nm KrF (krypton fluoride), 193-nm ArF (argon-fluoride) lithography systems, or e-beam lithography systems. The arrays are typically separated with spaces between each other in ultra-high density, high density, medium density, or low density. At ultra-high density, separation is less than 250 nm. At high density, separation is 300 to 350 nm. At medium density, separation is 400 nm to 500 nm. At low density, separation is 500 nm or more. In some implementations (for example, some low density implementations) 2-dimensional patterning with photoresist is sufficient to sequester DNA nanoballs or other discrete nucleic acid samples. In some implementations (for example, some medium, high, or ultra-high density implementations), to reduce risk that discrete samples will not remain in single locations, smaller samples may be required, which may require 3-dimensional patterning for more efficient capturing of fluorescence from tagged DNA nanoballs or other tagged nucleic acid samples. In such implementations, 3-dimensional patterned well nanostructures can be developed by non-binding material as a well wall and binding material for the well bottom surface for sequestering DNA nanoballs.

The second member 104 of the FIG. 1 flow cell 100 may be made of a material or materials that is substantially transparent to radiation wavelength(s) used to stimulate emissions from tagged templates 110, and also substantially transparent to radiation wavelength(s) of the emissions from tagged template 110 sites. The second member 104 may also be of a material or materials that does not generate substantial emissions in the wavelength range(s) of the stimulated emissions from tagged template 110 sites (e.g. via fluorescence of the substrate material itself or by inelastic photon scattering processes like Raman Scatter). As used in this paragraph, “substantially” and “substantial” refers to levels that would interfere with stimulation and/or detection of the emissions from tagged template 110 sites.

The material or materials of the second member 104 of the FIG. 1 flow cell 100 may also be substantially transparent to radiation wavelength(s) used to increase the temperature in the reaction space 108 of the flow cell 100 via heating fixture 300. As used in this paragraph, “substantially” and “substantial” refers to levels that would interfere with regulating the temperature in reaction space 108. In some implementations the second member 104 may be substantially transparent to at least radiation wavelength(s) in the range of 930 nm-950 nm, in the range of 900 nm-1000 nm, or in the range of 750 nm-1050 nm. In these or other implementations the second member 104 may be made of a material or materials having an absorption coefficient (/cm) at 300K that is greater than 1 at wavelengths below 1050 nm and a reflectivity that is less than 0.35 at wavelengths above 750 nm.

In one implementation, second member 104 is glass or another suitably optically transparent material.

In the example shown in FIG. 1 the first and second members 102, 104 are secured to one another and spaced apart by a defined distance by an adhesive 116 that defines a frame about the perimeter of the flow cell 100. In other implementations the flow cell may be frameless, with the flow cell members secured to one another in other manners. In these alternative implementations fluid outlets 114 like shown in FIG. 1 would not necessarily be required and the flow cell system may be configured such that fluid exits the flow cell from the gap between the two members at the outer perimeter of the flow cell.

The thermal systems and methods described herein may be configured to cycle temperatures of relatively large flow cells quickly, accurately, and uniformly. In some implementations, flow cells may have reaction spaces (e.g. the surface area of first member 102 of flow cell 100 where nucleic acid templates 110 are bound) of at least 150 cm². In some implementations, flow cells may have reaction spaces with an area in the range of an area in the range of 70 cm² to 750 cm². In various implementations the flow cell and its reaction space may have a square, rectangular, circular, or other shape.

### Cooling Fixture

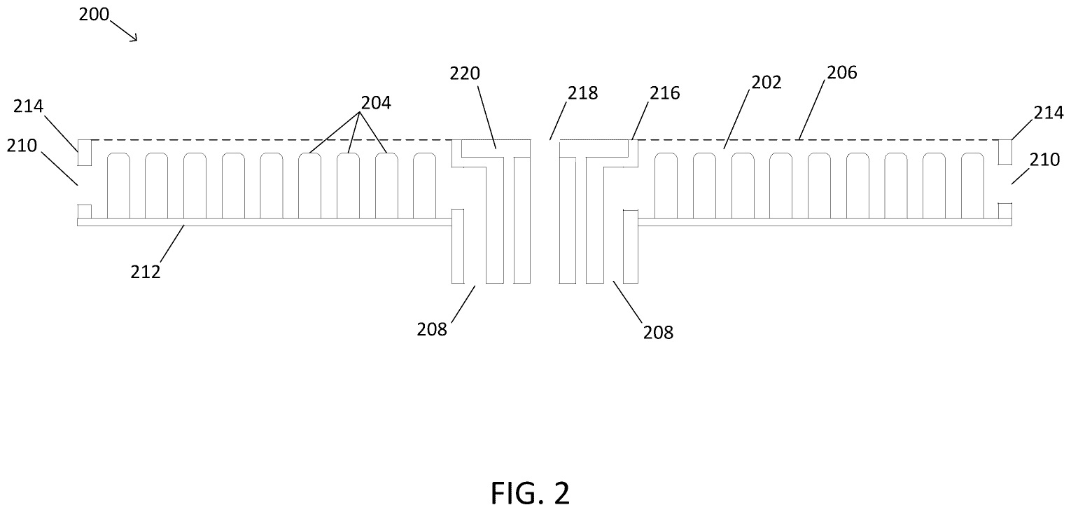

The cooling fixture 200 in the FIG. 1 example is configured to reduce the temperature in the reaction space 108 of the flow cell 100 when the cooling fixture 200 is operating. The cooling fixture 200 is also shown in FIG. 2, shown separated from the flow cell 100 and heating fixture 300 of FIG. 1. The cooling fixture 200 of FIGS. 1 and 2 includes a turbulent air flow cavity 202, an arrangement of air flow diverters 204 in the cavity 202, and an opening 206. When the flow cell 100 is positioned on the cooling fixture 200, the first member 102 of the flow cell 100 extends across and covers the opening 206 of the cooling fixture 200.

The turbulent air flow cavity 202 of the cooling fixture 200 has a size and shape that substantially corresponds size and shape of the area defined by reaction space 108 of the flow cell 100. In some implementations, the turbulent air flow cavity 202 of the cooling fixture 200 has an area (as measured by the area defined by opening 206 in the cooling fixture 200) that is at least 70% of the area defined by reaction space 108 of the flow cell 100, or at least 80% of the area defined by reaction space 108 of the flow cell 100, or at least 90% of the area defined by reaction space 108 of the flow cell 100.

The cooling fixture 200 of FIGS. 1 and 2 includes air inlets 208 and air exhausts 210 that are in fluid communication with the turbulent air flow cavity 202. During operation of the cooling fixture 200, cooled air enters the turbulent air flow cavity 202 through the air inlets 208, flows in a turbulent fashion pas the air flow diverters 204, and exhausts from the turbulent air flow cavity 202 via the air exhausts 210.

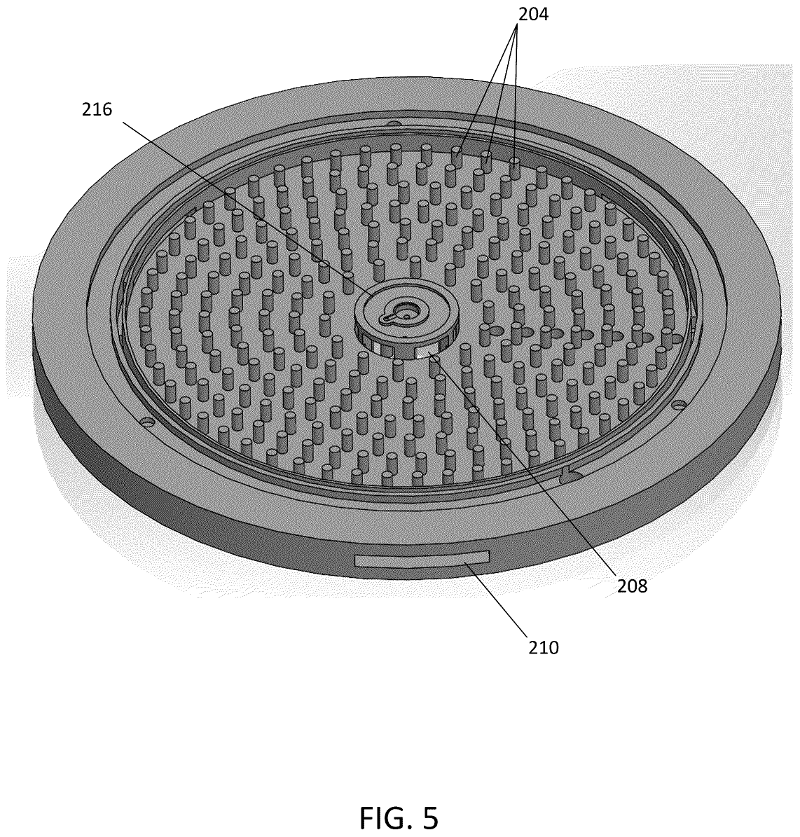

The air flow diverters 204 in the example of FIGS. 1 and 2 are arrayed across and extend upwards from the cavity floor 212 of the turbulent air flow cavity 202. FIG. 5 shows another example of an array of air flow diverters 204. In this example, the air flow diverters 204 are cylindrical pins extending most of the way or entirely to the opening 206 in the turbulent air flow cavity 202. In other implementations, air flow diverters may be shaped, configured, and arranged in different fashions while still imparting turbulence to the air flow through the cavity. The air flow diverters 204 shown in the figures also help to equalize the air under the flow cell during heating in addition to providing turbulent flow that reduces the boundary layer thereby increasing heat transfer efficiency and achieving more uniform temperature at the flow cell.

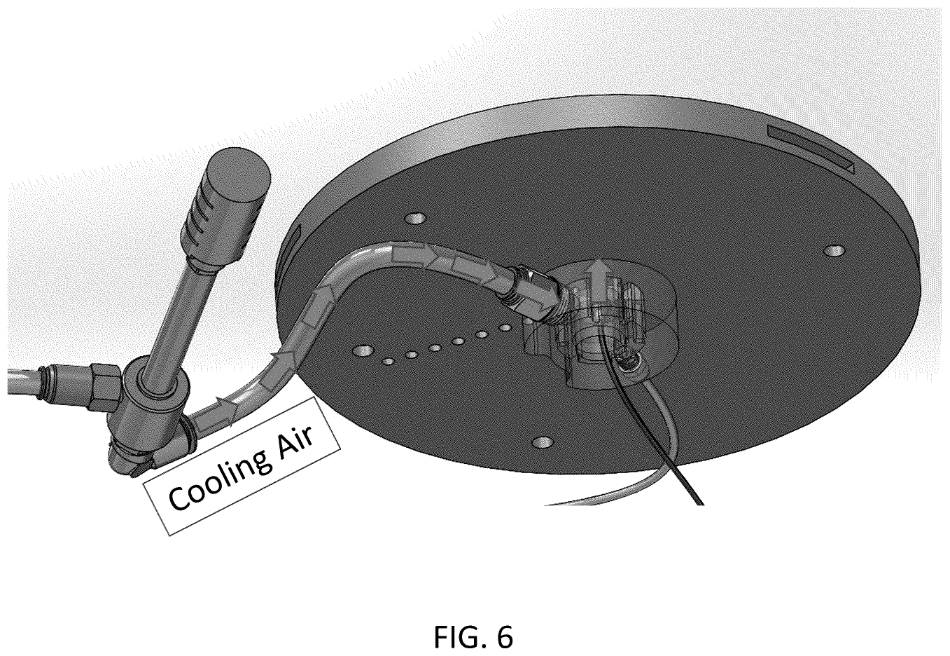

In the example of FIGS. 1 and 2 and also in the example of FIGS. 5 and 6, the air inlets 208 are centrally located in the turbulent air flow cavity 202 and the air exhausts 210 (only one of which is shown in FIG. 5) are located about and extend through a peripheral wall 214 of the cavity 202. In some implementations, the number, geometry, and spacing of the inlets 208 and exhausts 210 may be configured to allow for sufficient cooling air flow throughout the entirety of cavity 202. In the particular example shown in FIG. 5 there are six air inlets 208 and three air exhausts 210.

In the examples of FIGS. 1-2 and 5-6 the air inlets 208 are located in and extend through the sidewall of a centrally located boss 216 that extends upwards from the cavity floor 212. A topside of the boss 216 also includes a fluidic connection 218 for introducing a fluid into the fluidic passage of the flow cell 100 via inlet 112, and a vacuum chamber 220 for retaining the flow cell 100 on the cooling fixture 200 by vacuum negative pressure.

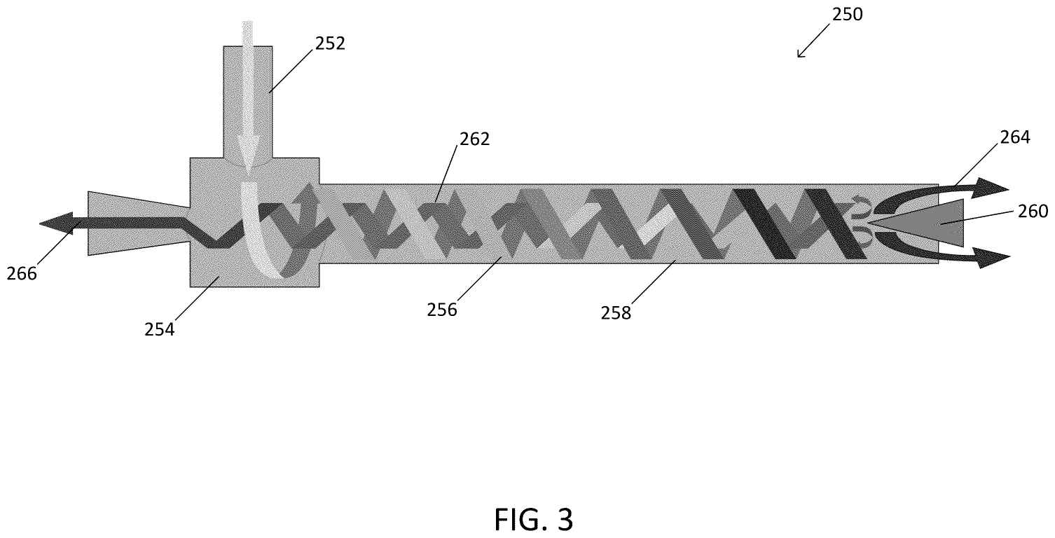

In the example of FIGS. 5-6 cooled air is supplied to the turbulent air flow cavity 202 by a vortex tube 250. FIG. 3 shows a schematic representation of one example of a vortex tube 250. In some implementations, a vortex tube converts compressed air into separate hot and cold streams of air, with the hot air steam exhausted as waste and the cold air steam used for cooling. Such a vortex tube works without moving parts and does not require refrigerant gasses such as Freon to operate. In the schematic example of FIG. 3, compressed air tangentially enters the vortex tube 250 at inlet 252 and is directed into a vortex generator 254 where the air flow begins to rapidly rotate and form an outer vortex 256 that extends along tube 258. A conical valve 260 at the distal end of the tube 258 redirects some of the air flow back along the tube 258 as an inner vortex 262 and allows the remainder of the air flow to exhaust 264. As the inner vortex 262 flows back through the tube 258 heat is transferred from it to the outer vortex 256. In this manner, the air flow of the outer vortex 256 at the distal exhaust 264 is significantly hotter than the inner vortex 262 by the time the inner vortex 262 reaches the cool air exhaust 266.

In some implementations the vortex tube may be configured to provide cooling capacities of at least 1,000 BTU/hour, at least 2,000 BTU/hour, at least 3,000 BTU/hour, or at least 4,000 BTU/hour. In some implementations the vortex tube may be operated at flow rates of at least 20 SCFM, at least 30 SCFM, at least 40 SCFM, or at least 50 SCFM.

The thermal system may be configured to operate the cooling fixture 200 when the sequencing process reaches a certain point or points in the process. The thermal system may be further configured to monitor the temperature of the reaction space 108 or other components (e.g. using feedback from one or more thermocouples or other types of temperature sensors) to determine when the reaction space 108 has reached the desired temperature state such that operation of the cooling fixture 200 should be discontinued or otherwise altered. In other implementations, the thermal system may be configured to operate the cooling fixture 200 for certain set amounts of time when the sequencing process recaches a certain point or points in the process. In still other implementations, the cooling fixture 200 may run continuously or semi-continuously throughout the sequencing process, and “operation” of the cooling fixture 200 may constitute increasing air flow through the turbulent air flow cavity 202 to increase the cooling effect of the cooling fixture 200.

The cooling fixture 200 including the turbulent air flow cavity 202 and the vortex tube 250 described above are configured to be operated to reduce temperature of the reaction space 108 of the flow cell in a fast and accurate manner. In some implementations, the cooling fixture 200 may be operated to reduce the temperature of the whole reaction space 108 of an 8-inch round flow cell 100 from 60 degrees Celsius to below 30 degrees Celsius in less than 17 seconds.

### Heating Fixture

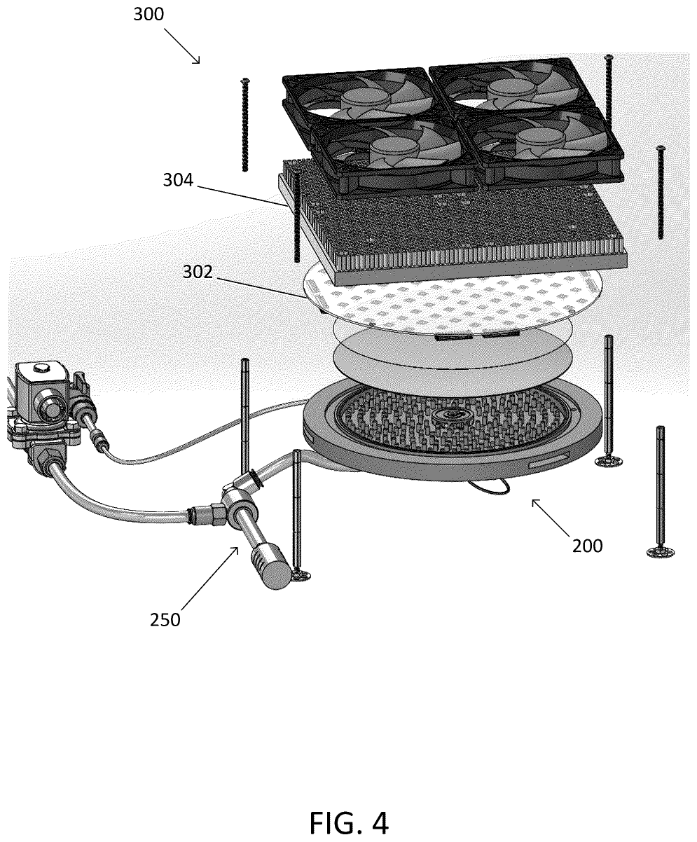

The heating fixture 300 in the FIG. 1 example is configured to raise the temperature in the reaction space 108. The heating fixture 300 includes an array of light emitting diodes 302 configured to emit infra-red light incident on the second member 104 of the flow cell 100. The heating fixture also includes a 1-inch depth shallow heat sink 304 with very low thermal resistance (0.076° C./W) and may further include (as shown in FIG. 4) fans to facilitate further removal of excess heat from the heating fixture 300.

As shown in FIG. 1 the light emitting diodes 302 are spaced apart from and do not physically contact the flow cell 100. In some implementations, the light emitting diodes 302 may be spaced apart from the outer surface of second member 104 by at least 20 mm, by at least 30 mm, by at least 40 mm, by at least 50 mm, or by other spacings.

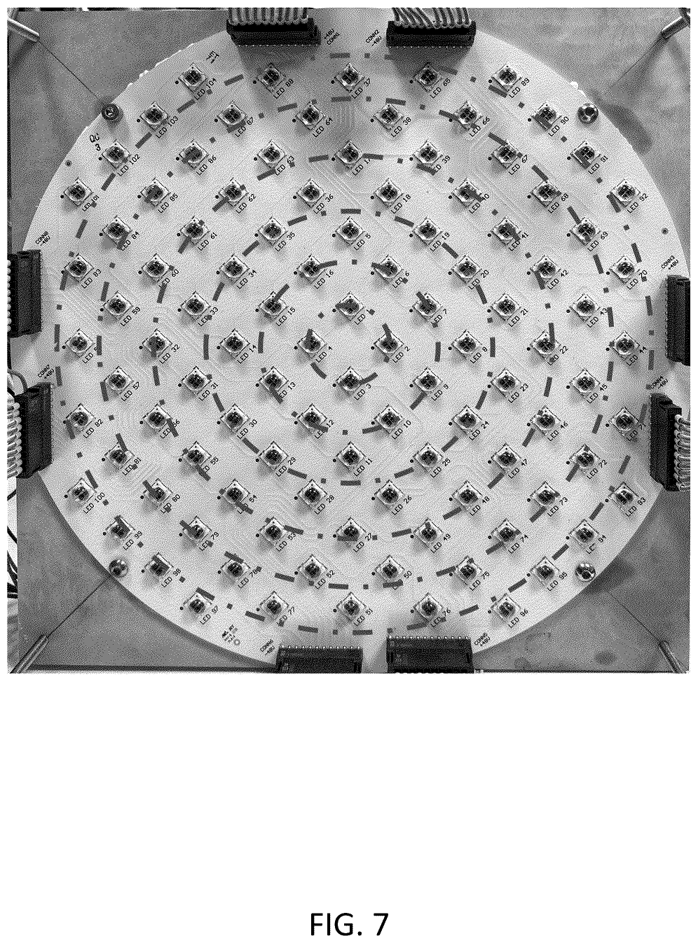

FIG. 7 shows the underside of an example heating fixture 300 including a spaced array of light emitting diodes 302. The array of light emitting diodes 302 may be approximately the same size as the reaction space 108 of the flow cell 100. For example, a flow cell 100 with an approximately 200 mm diameter reaction space 108 would be heated by an array of light emitting diodes 302 in which the diode arrangement of the array is also approximately 200 mm in diameter.

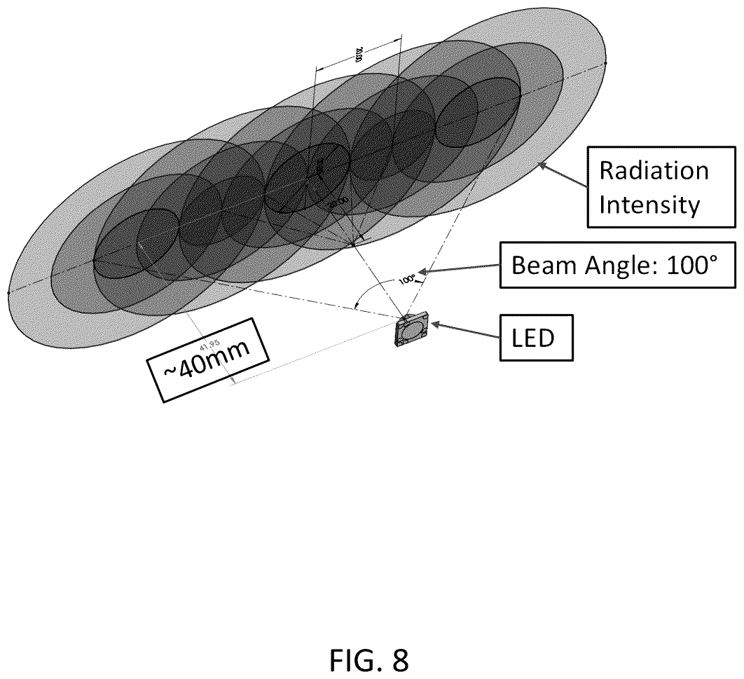

In FIG. 7 the light emitting diodes 302 are positioned relative to one another such that their radiation profiles overlap with radiation profiles of adjacent light emitting diodes 302 to provide a relatively uniform heating effect across the reaction space 108. In at least some implementations, the overlap of radiation profiles of adjacent light emitting diodes 302 will be a function of the light emitting diode's beam angle and radiation intensity profile in combination with the relative spacing of the light emitting diodes to one another and the distance at which the light emitting diode array is spaced from the flow cell. In one particular example as shown in FIG. 8, light emitting diodes with a 50% radiation intensity at a 100 degree beam angle may be spaced from the second member 104 of flow cell 100 by 40 mm and spaced from adjacent light emitting diodes 302 in the array by 20 mm to achieve approximately 50% overlap radiation at every location of the array's illumination profile. The LED's with 100 degree beam angle shown in FIG. 8 project to the heated object (flow cell), with each 20 mm spaced area on flow cell being covered into 50%˜100% radiation intensity area for the LED directly above, and also covered by adjacent LED projected 50% radiation intensity area. Test for difference distance between LED and flow cell were done, such as 20 mm, 35 mm, 40 mm, 45 mm, 50 mm, 60 mm, 20 mm gives the best result in some implementations, since the 20 mm diameter area on flow cell is 90%˜100% direct project area, but 40 mm is more optimized in some implementations due to more propriate space under LED and above the flow cell and relative even temperature uniformity and similar ramping up time. Those of skill in the art will appreciate this as just one example, and that light emitting diode arrays of LED's with various properties can be configured and arranged in other ways to provide similar effects.

The thermal system may be configured to operate the heating fixture 300 when the sequencing process reaches a certain point or points in the process. The thermal system may be further configured to monitor the temperature of the reaction space 108 or other components (e.g. using feedback from one or more thermocouples or other types of temperature sensors) to determine when the reaction space 108 has reached the desired temperature state such that operation of the heating fixture 300 should be discontinued or otherwise altered. In other implementations, the thermal system may be configured to operate the heating fixture 300 for certain set amounts of time when the sequencing process recaches a certain point or points in the process. In still other implementations, the heating fixture 300 may generate illumination continuously or semi-continuously throughout the sequencing process, and “operation” of the heating fixture 300 may constitute increasing intensity of the illumination to increase the heating effect of the heating fixture 300.

The heating fixture 300 described above is configured to be operated to raise temperature of the reaction space 108 of the flow cell in a fast, accurate, and uniform manner. In some implementations, the heating fixture 300 may be operated to increase the average temperature of the reaction space 108 of flow cell 100 by at least 35 degrees Celsius (from room temperature to 50 degrees Celsius) in less than 20 seconds. In some implementations, when the reaction space 108 is in the heated state, the temperature across the reaction space 108 varies by less than 1 degrees Celsius.

### Method of Operation

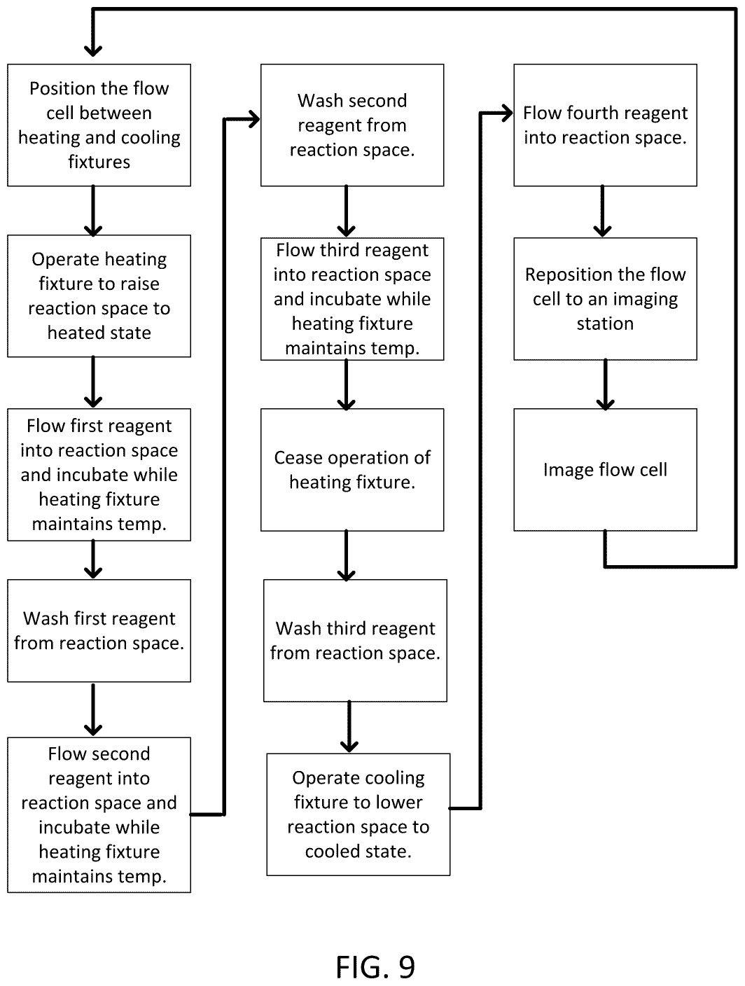

FIG. 9 illustrates one example of a method using the thermal system example described above. Initially, a flow cell is positioned between the heating and colling fixtures and held on top of the cooling fixture by vacuum. The heating fixture is operated to raise the fluid in the reaction space to a heated state (e.g. 60 degrees Celsius). A first reagent is flowed into the reaction space and remains in the reaction space for an incubation period and then washed out. A second reagent is then flowed into the reaction space and remains in the reaction space for an incubation period and then washed out. A third reagent is then flowed into the reaction space and remains in the reaction space for an incubation period. During the incubation periods the temperature of the flow cell is monitored and provides feedback to the heating sub-system to maintain the reaction space at the heated space. After the third incubation period the operation of the heating fixture ceases, the third reagent is washed out, and the cooling fixture is operated to lower the reaction space to a cooled state. A fourth reagent is then flowed into the reaction space and the flow cell is repositioned to an imaging station where it is imaged. The flow cell is then repositioned back to the heating and cooling fixtures and the process is repeated for as many cycles as desired.

### Experimental Results

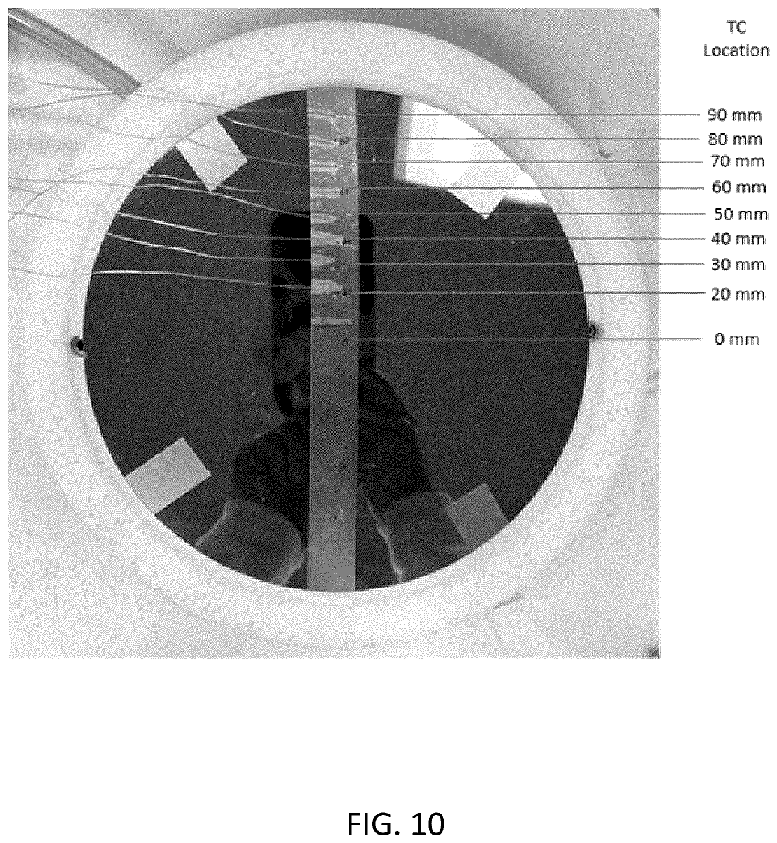

The inventors have discovered that the thermal systems described above provide unexpectedly fast, precise, and uniform control over temperature in relatively large flow cells. FIGS. 10-25 summarize experiments conducted using the thermal system illustrated in FIGS. 4-8 and described above.

FIGS. 10-12 summarize a first experiment. FIG. 10 shows thermocouple K type wires (diameter of 0.08 mm) mounted on a 200 mm diameter wafer representing a 200 mm diameter flow cell. The thermocouples were mounted on top of the wafer along a linear radius at 20 mm, 30 mm, 50 mm, 70 mm, 80 mm, and 90 mm from the center of the wafer. Note that the 10 mm and 60 mm thermocouples shown in FIG. 10 were not used for this experiment. The thermal system described above was used to repeatedly heat the temperature of the flow cell to approximately 60 degrees Celsius and cool the flow cell below 30 degrees Celsius. Starting from room temperature, the thermal system's heating fixture was operated to raise the temperature of the flow cell with nucleic acid analyte and reagent fluid inside at a target temperature of approximately 60 degrees Celsius in approximately 17 seconds. A PID control system was used to control operation of the LED's voltage supply based on feedback from the thermocouples to maintain the flow cell temperature at approximately 60 degrees Celsius in real time. After an incubation period, the heating fixture was shut off and the cooling fixture was operated to lower the temperature of the flow cell below 30 degrees Celsius in approximately 17 seconds.

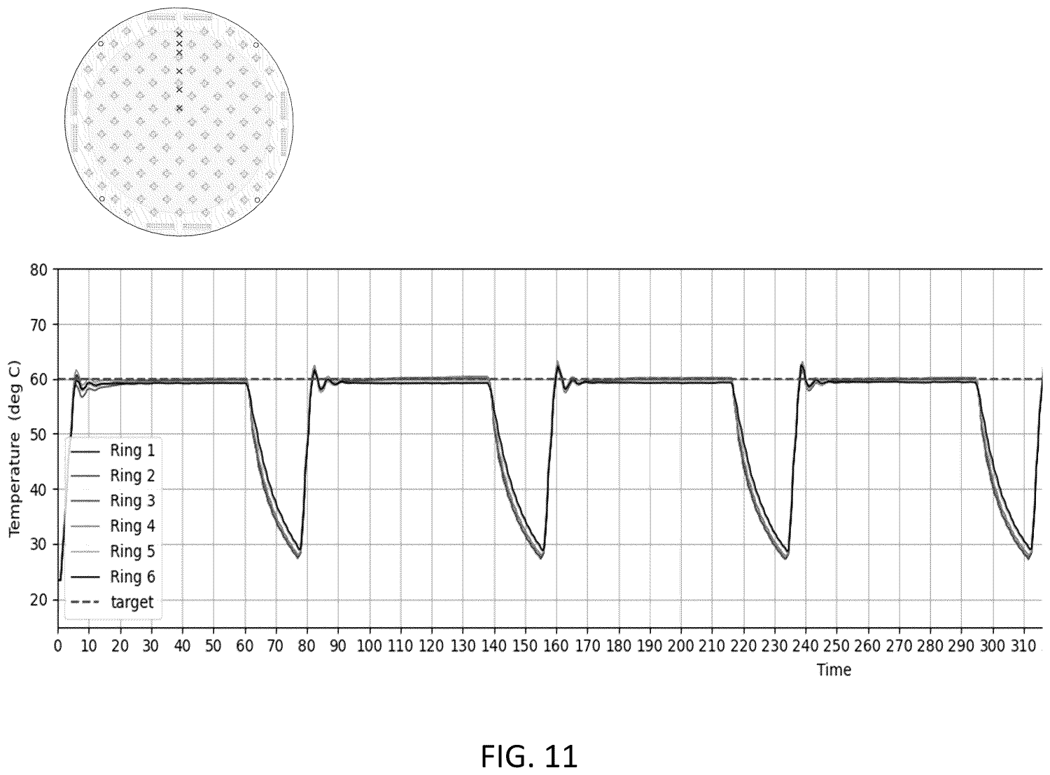

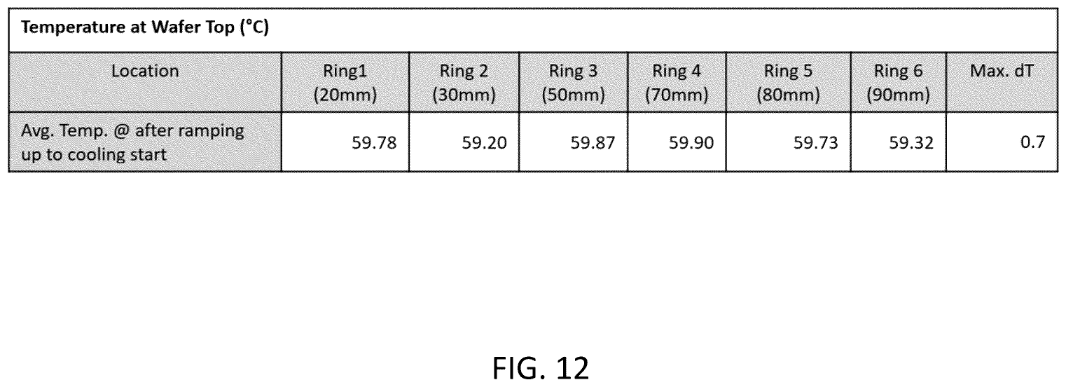

These heating and cooling processes were repeated over 300 cycles. FIGS. 11 and 12 show the results of this experiment. FIG. 11 shows the temperature over time as read by the thermocouples at 20 mm (“ring 1”), 30 mm (“ring 2”), 50 mm (“ring 3”), 70 mm (“ring 4”), 80 mm (“ring 5”), and 90 mm (“ring 6”). As shown in FIG. 11, the heating fixture raised the temperature from room temperature to approximately sixty degrees Celsius at all rings in approximately 17 seconds. As shown in FIG. 11, the cooling fixture lowered the temperature from approximately sixty degrees Celsius to below 30 degree Celsius in approximately 17 seconds. FIG. 12 shows the average temperature at rings 1-6 over the time period from 18 seconds to 90 seconds. As shown in FIG. 12, these averages had a maximum difference in temperature equal or below 1.0 over this time period.

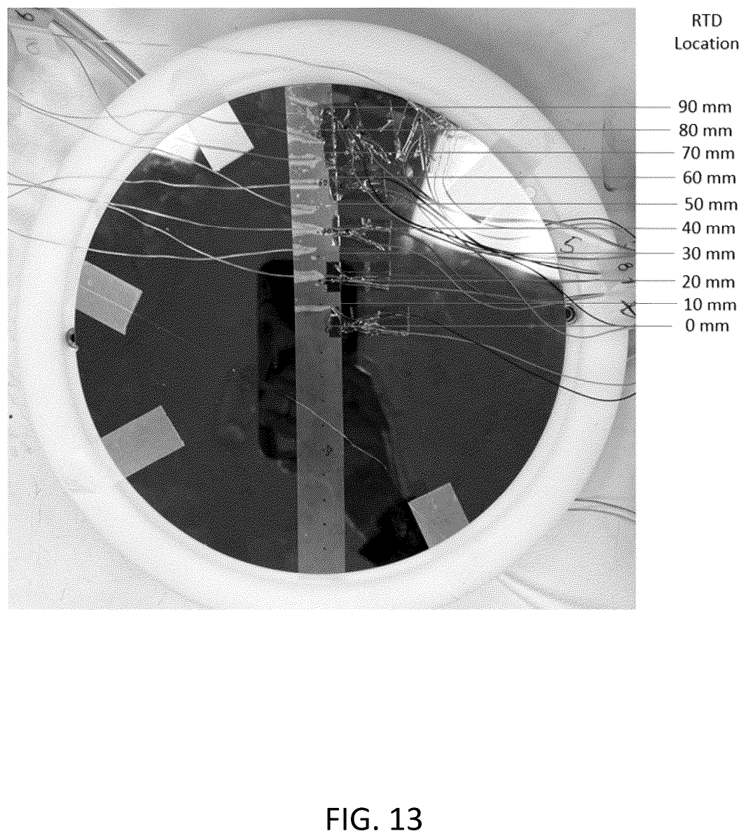

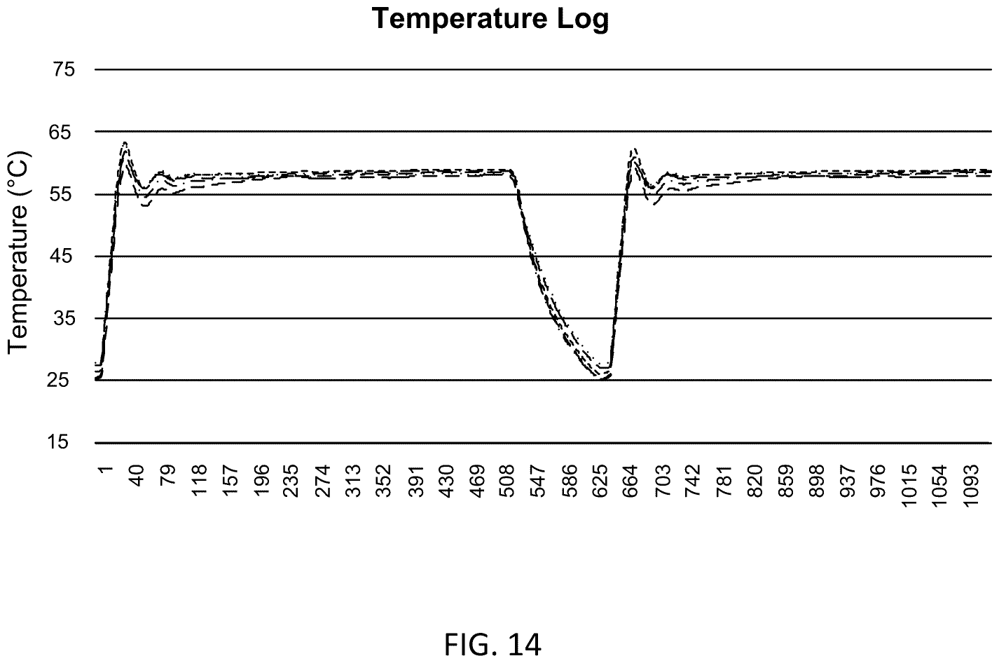

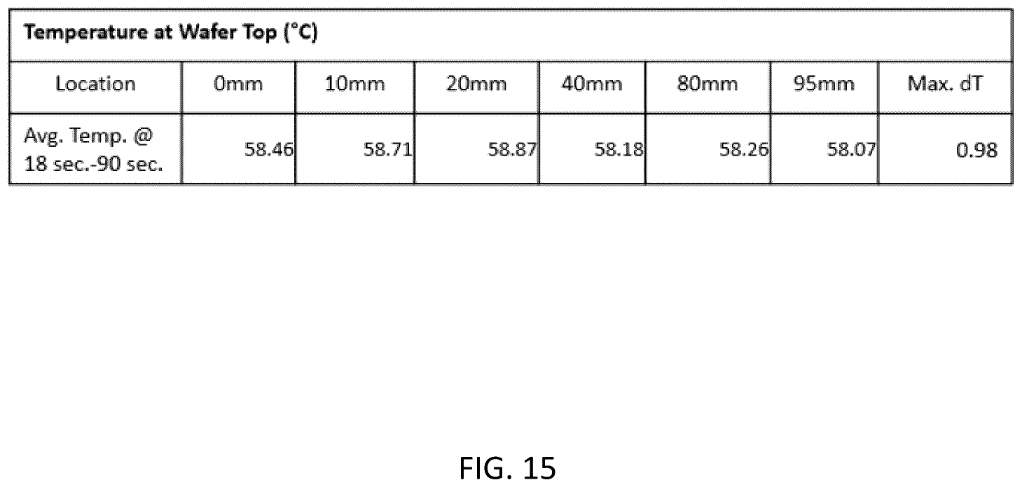

FIGS. 13-15 summarize a second experiment the same set up as the first experiment except that resistance temperature detectors (thin film PT 1000 with a response time of 0.2-0.4 seconds) were used instead of thermocouples, and data was collected by a data acquisition system DAQ970A+DAQM901A. RTD in general assure a higher accuracy than thermocouple, this specific RTD used in this test has an accuracy as 100.00±0.06 As can be seen in FIGS. 14-15, similar performance results were obtained in this experiment as were obtained in the first experiment. Temperature uniformity equal or below 1 degree Celsius across the whole 8-inch flow cell has been verified for both temperature sensor, due to the much fast response and smaller profile, thermocouple is used for continuing development and cycles.

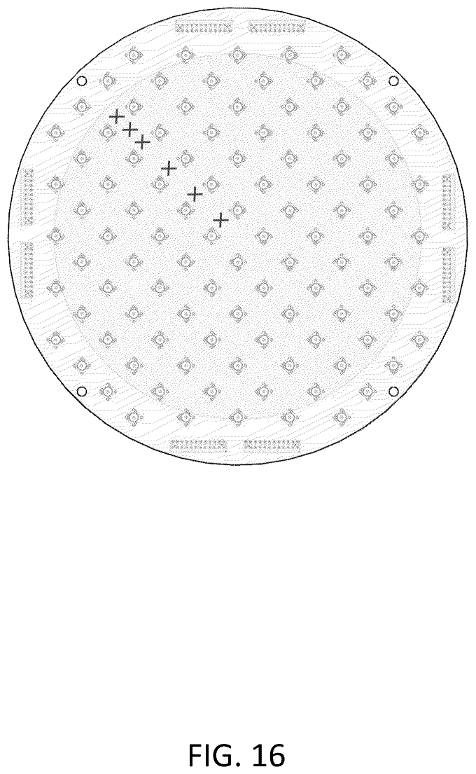

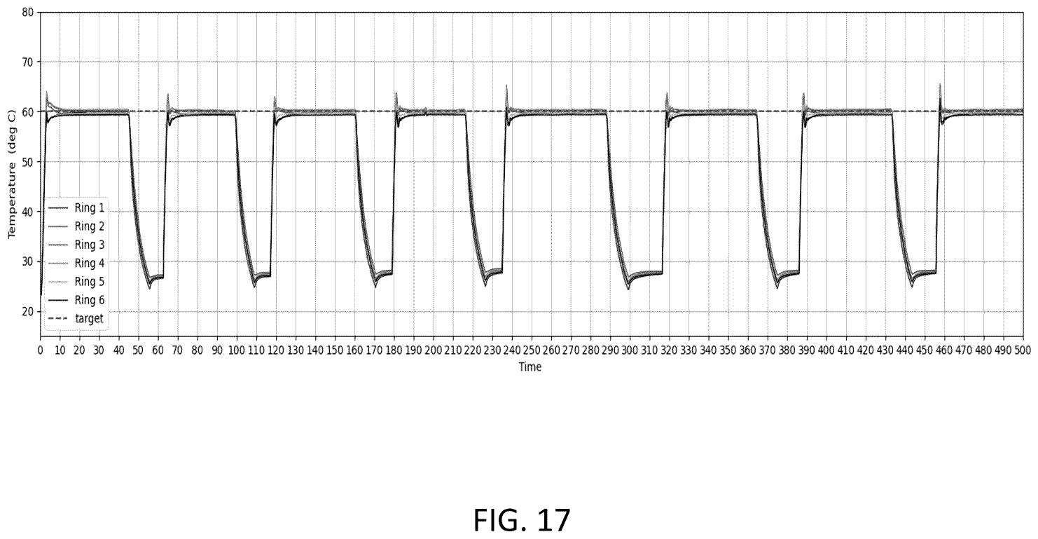

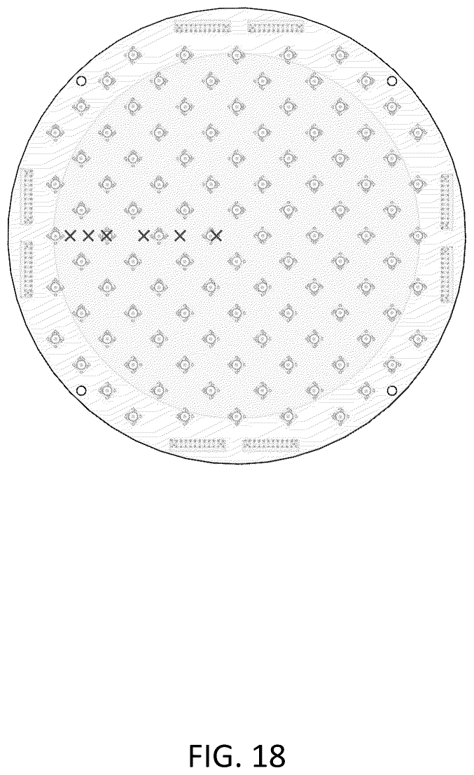

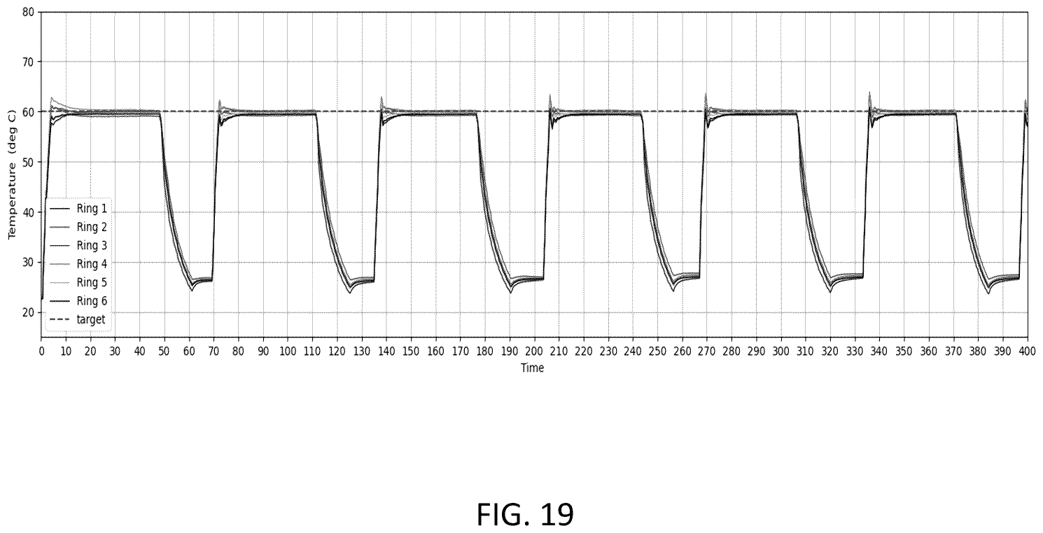

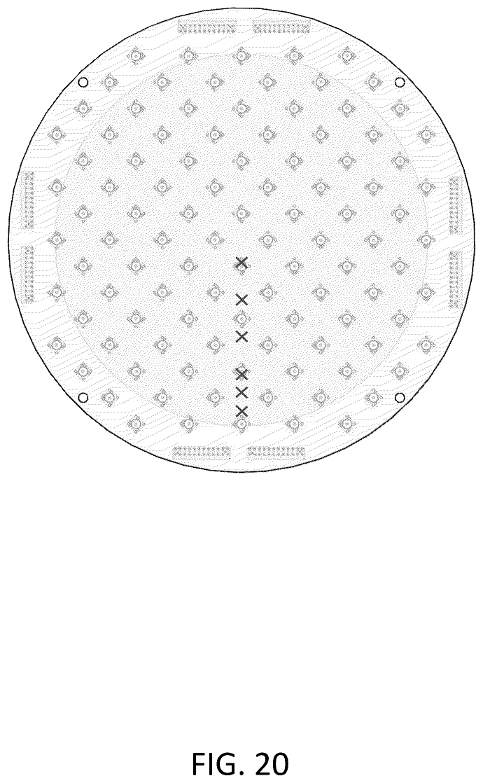

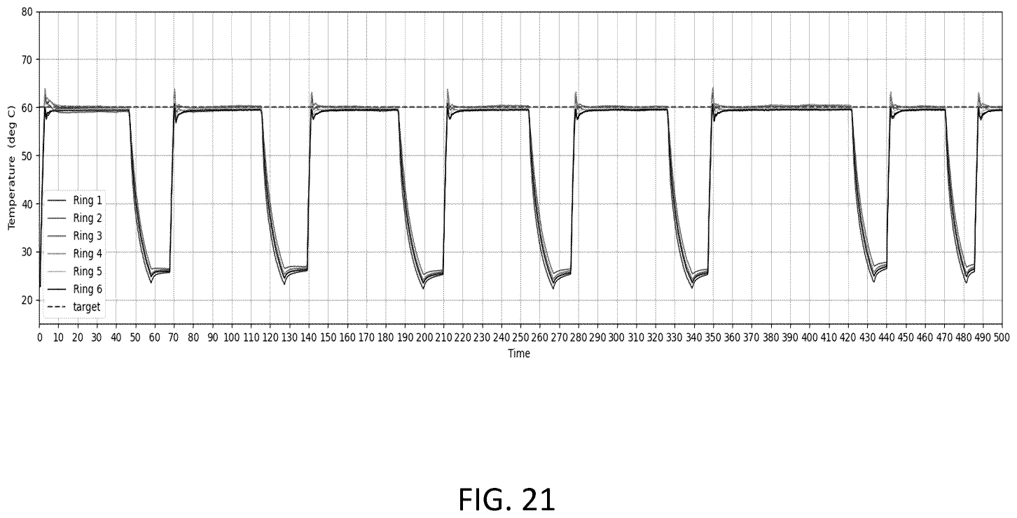

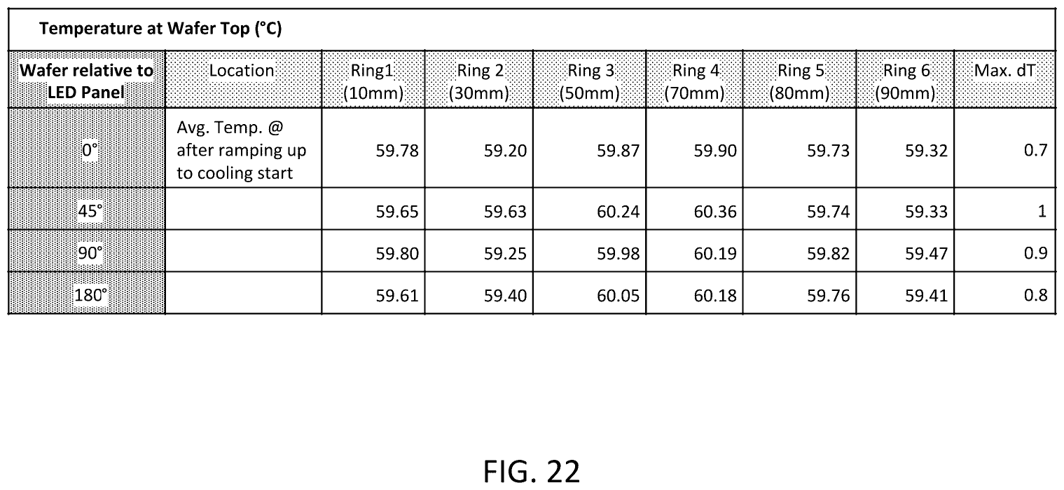

The experiment of FIGS. 10-12 was also repeated with the wafer positioned at different rotational positions relative to the heating fixture. FIGS. 16-17 show the wafter rotated 45 degrees relative to its position from the experiment of FIGS. 10-12 and the results from the experiment being re-run with the wafer rotated 45 degrees. FIGS. 18-19 show the wafter rotated 90 degrees relative to its position from the experiment of FIGS. 10-12 and the results from the experiment being re-run with the wafer rotated 90 degrees. FIGS. 20-21 show the wafter rotated 180 degrees relative to its position from the experiment of FIGS. 10-12 and the results from the experiment being re-run with the wafer rotated 180 degrees. As shown by the results of FIGS. 17, 19, and 21, which are summarized at FIG. 22, the heating fixture was able to regulate temperature uniformly regardless of the rotational position of the wafer relative to the thermal system.

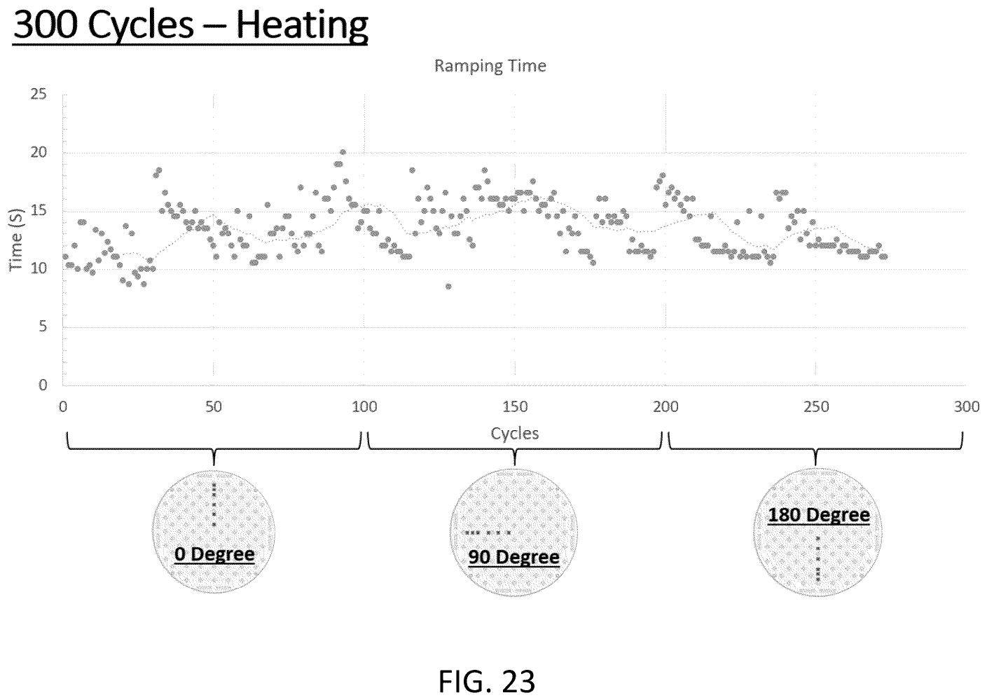

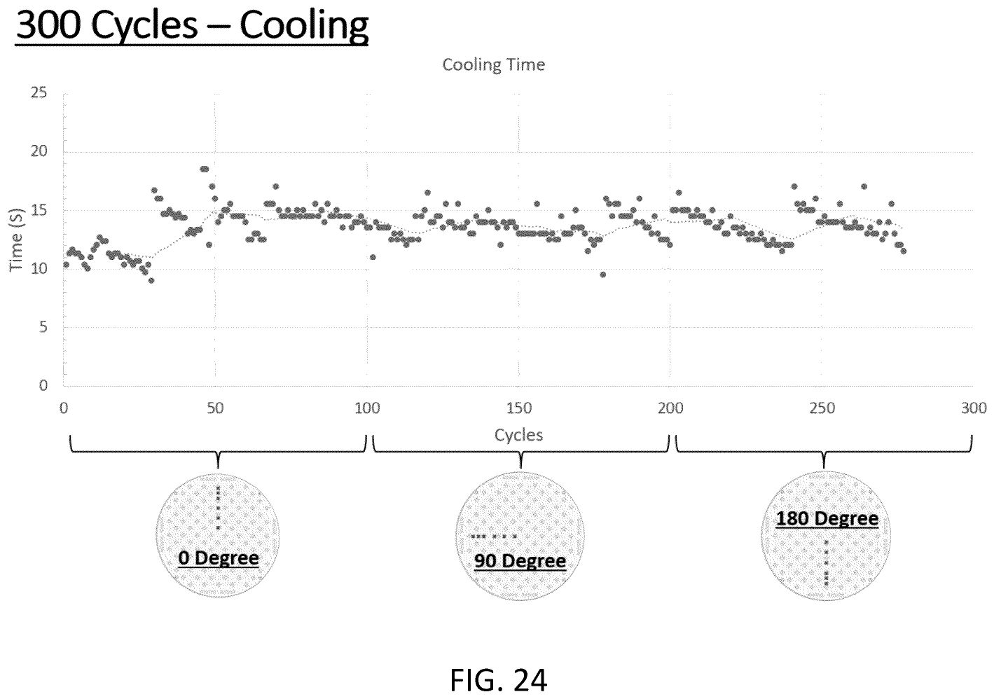

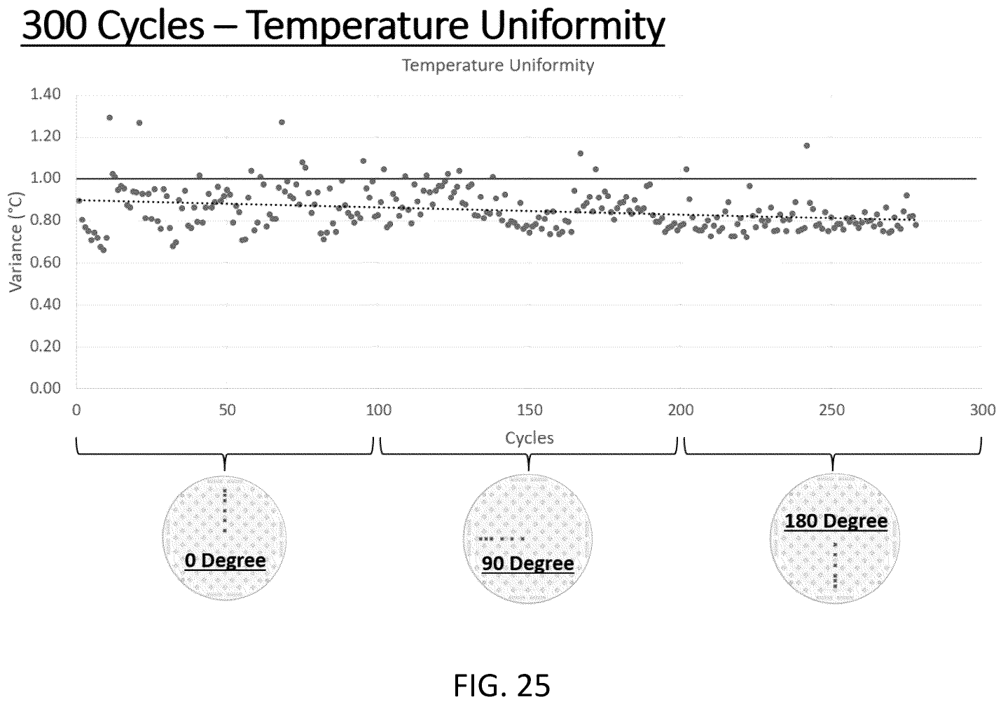

FIGS. 23-25 show additional experimental results over the course of 300 heating and cooling cycles (between 60 and 30 degrees Celsius respectively) in which three sets of 100 cycles were carried out at 0, 90, and 180 degrees of rotation between the test wafer on one hand and the heating and cooling fixtures on the other hand. As shown in FIG. 23, heating ramping times to 60 degrees Celsius were consistently between approximately 10 and 20 seconds and were not meaningfully impacted by rotational position of the test wafer relative to the heating and cooling fixtures. As shown in FIG. 24, cooling times to 30 degrees Celsius were consistently between approximately 10 and 17 seconds and were not meaningfully impacted by rotation position of the test wafer relative to the heating and cooling fixtures. As shown in FIG. 25, spatial variance of temperature was minimal across the test wafer and was not meaningfully impacted by rotational position of the test wafer relative to the heating and cooling fixtures.

### Electrowetting

FIGS. 1-25 illustrate examples of thermal system used in connection with flow cells, such as flow cells of nucleic acid sequencing systems. The thermal systems described herein, however, are not limited to use in conjunction with nucleic acid sequencing systems. The thermal systems described herein may also be used with other microfluidic devices. In one additional exemplary implementation, the thermal systems described herein may be used with systems incorporating electrowetting-on-dielectric (EWOD) technology. EWOD is a liquid driving mechanism to change a contact angle of an aqueous droplet between two electrodes on a hydrophobic surface. A bulk liquid droplet as large as several millimeters (i.e., several microliters in volume) can be moved by an array of electrodes disposed on a substrate, such as an inorganic substrate (e.g., silicon/glass substrate) or organic substrate (e.g., a cyclic olefin polymer/polycarbonate substrate).

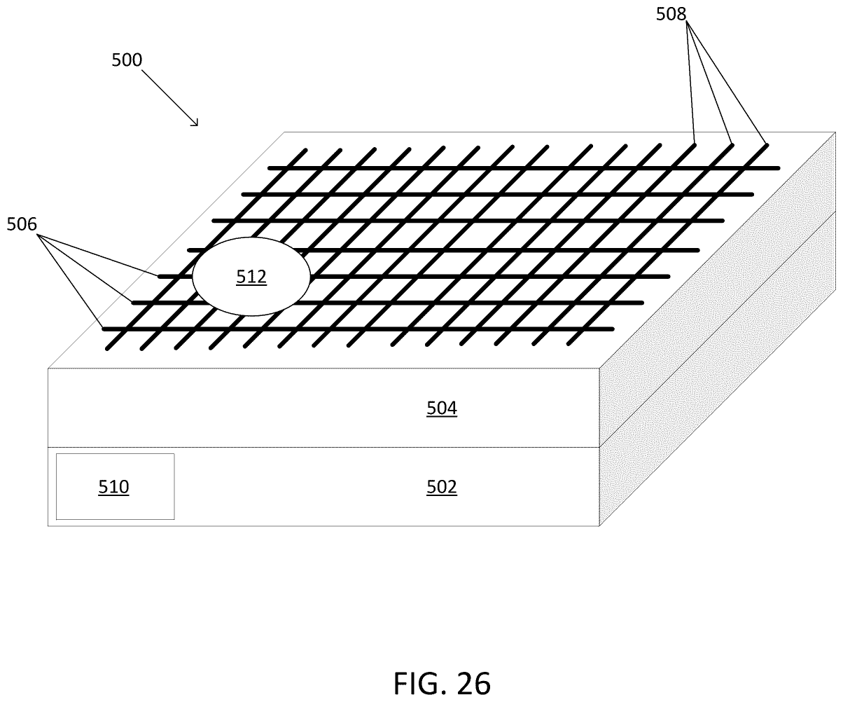

FIG. 26 schematically shows an example of an EWOD device 500. EWOD device includes a substrate 502 with an insulating layer 504 and an array of electrodes 506, 508 within or under the insulating layer 504. Electrodes 506 are arranged parallel to each other and spaced apart from each other in a first direction. Electrodes 508 are arranged parallel to each other and spaced apart from each other in a second direction substantially perpendicular to the first direction. The insulating layer 504 may include a plurality of dielectric layers of the same material or different materials. The EWOD device also includes an input-output circuit 510 in the substrate and operative to interface with an external control circuit to provide control voltages having time-varying voltage waveforms to the array of electrodes 506, 508. A liquid droplet 512 disposed on the surface of the insulating layer 504 may be moved along a certain direction by turning off and on control voltages at electrodes below the droplet and at adjacent electrodes. As shown in FIG. 26, the EWOD device may also include a second substrate 514 including an insulating layer 516 and a common electrode 518 embedded therein and facing the actuation electrodes 506, 508.

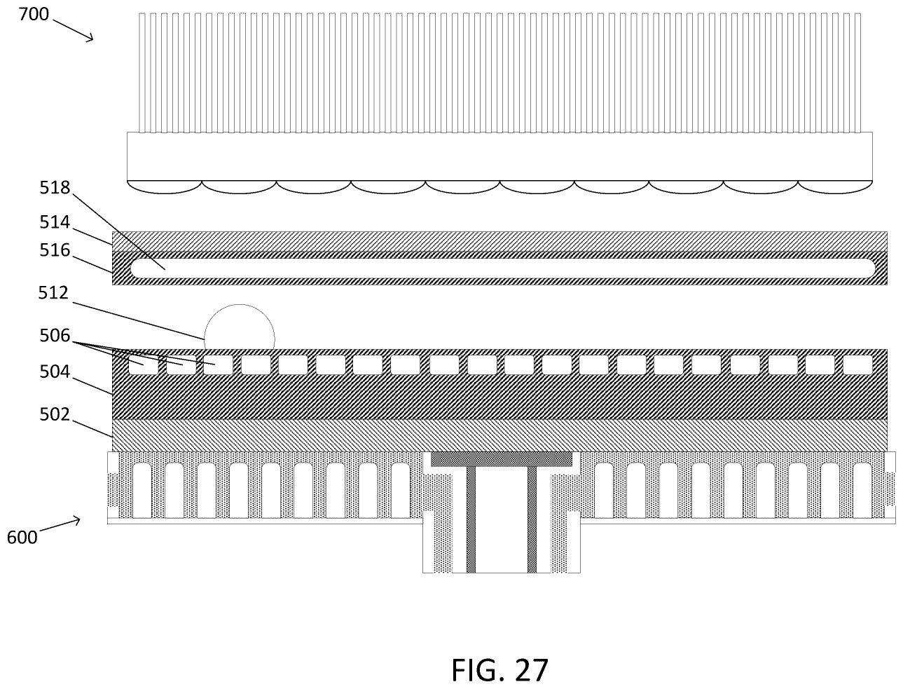

FIG. 27 shows the EWOD device 500 positioned with respect to a thermal system including a cooling fixture 600 and a heating fixture 700. The cooling and heating fixtures 600, 700 may include the same or similar components, configurations, and functionality of the cooling and heating fixtures discussed above in earlier examples, or may include different components, configuration, and functionality.

### CONCLUSION

As shown above, thermal systems incorporating the cooling and heating fixtures described herein provide for fast, accurate, and uniform regulation of temperature for flow cells and other microfluidic substates, especially microfluidic substrates with larger areas. It will be recognized that the above discussion has been provided by way of illustrative examples only, and that additions, deletions, substitutions, and other modifications may be made to the systems and methods described above without departing from the scope or spirit of the inventions set out in the following claims.

1. A microfluidic device thermal system comprising:
(a) a microfluidic device comprising a first member and a second member spaced apart from the first member to define a fluidic passage between the first and second members; and
(b) a cooling fixture configured to reduce the temperature in the fluidic passage, the cooling fixture comprising a turbulent air flow cavity, a plurality of air flow diverters in the cavity, and an opening, wherein the first member of the microfluidic device extends across and covers the opening.

2. The microfluidic device thermal system of claim 1, further comprising: a heating fixture configured to raise the temperature in the fluidic passage, the heating fixture comprising an array of light emitting diodes configured to emit infra-red light incident on the second member of the microfluidic device; wherein the system is configured to cycle the temperature of the fluidic passage through a plurality of states including at least one cooled state and at least one heated state.

3. The microfluidic device thermal system of claim 2, wherein the microfluidic device comprises a flow cell, the flow cell defining an analyte reaction space in the fluidic passage, wherein the first member comprises an array of nucleic acid template binding sites in the reaction space.

4. The microfluidic device thermal system of claim 3, wherein the reaction space in the fluidic passage has an area of at least 70 cm².

5. The microfluidic device thermal system of claim 4, wherein the reaction space in the fluidic passage has an area in the range of 70 cm² to 750 cm².

6. The microfluidic device thermal system of claim 2, wherein the cooling fixture further comprises an air inlet in fluid communication with the turbulent air flow cavity and an air exhaust in fluid communication with the turbulent air flow cavity, and wherein during operation of the cooling fixture cooled air enters the turbulent air flow cavity through the air inlet, flows in a turbulent fashion past the air diverters, and exhausts through the air exhaust.

7. The microfluidic device thermal system of claim 6, wherein the air inlet comprises a plurality of centrally located air inlets in the turbulent air flow cavity, and wherein the air exhaust comprises a plurality of peripherally located air exhausts from the turbulent air flow cavity.

8. The microfluidic device thermal system of claim 6, wherein the turbulent air flow cavity comprises a cavity floor, wherein the plurality of air flow diverters are arrayed across the cavity floor.

9. The microfluidic device thermal system of claim 8, wherein the plurality of air flow diverters extend upwards from the cavity floor towards the opening of the turbulent air flow cavity.

10. The microfluidic device thermal system of claim 8, wherein the cooling fixture further comprises a centrally located boss that extends upwards from the cavity floor, wherein the air inlet comprises a plurality of air inlets located in one or more sidewalls of the boss.

11. The microfluidic device thermal system of claim 10, wherein the boss further comprises a top side including: (i) a fluidic connection for introducing a fluid into the fluidic passage of the flow cell, and (ii) a vacuum chamber for retaining the flow cell on the cooling fixture by vacuum negative pressure.

12. The microfluidic device thermal system of claim 2, wherein cooled air is supplied to the turbulent air flow cavity by a vortex tube.

13. The microfluidic device thermal system of claim 12, wherein the vortex tube comprises a compressed air inlet, a stationary vortex generator, a hot air exhaust, and a cool air exhaust; wherein the cool air exhaust is in fluid communication with the turbulent air flow cavity.

14. The microfluidic device thermal system of claim 12, wherein operation of the vortex tube to supply cool air to the turbulent air flow cavity reduces an average temperature in the fluidic passage by at least 15 degrees Celsius in less than 45 seconds.

15. The microfluidic device thermal system of claim 12, wherein operation of the vortex tube to supply cool air to the turbulent air flow cavity reduces an average temperature in the fluidic passage by at least 25 degrees Celsius in less than 30 seconds.

16. The microfluidic device thermal system of claim 15, wherein, when the fluidic passage is in the cooled state, the temperature across the fluidic passage varies by less than 2 degrees Celsius.

17. The microfluidic device thermal system of claim 16, wherein, when the fluidic passage is in the cooled state, the temperature across the fluidic passage varies by less than 1.5 degrees Celsius.

18. The microfluidic device thermal system of claim 3, wherein the array of light emitting diodes comprises a plurality of light emitting diodes configured to emit overlapping infra-red light beams incident on the second member.

19. The microfluidic device thermal system of claim 18, wherein the light emitting diodes of the plurality of light emitting diodes are spaced apart from one another and spaced away from the flow cell such that radiation profiles of adjacent light emitting diodes overlap.

20. The microfluidic device thermal system of claim 18, wherein operation of the array of light emitting diodes raises an average temperature of the fluidic passage by at least 15 degrees Celsius in less than 45 seconds.

21. The microfluidic device thermal system of claim 18, wherein operation of the array of light emitting diodes raises an average temperature of the fluidic passage by at least 25 degrees Celsius in less than 30 seconds.

22. The microfluidic device thermal system of claim 21, wherein, when the fluidic passage is in the heated state, the temperature across the fluidic passage varies by less than 2 degrees Celsius.

23. The microfluidic device thermal system of claim 21, wherein, when the fluidic passage is in the heated state, the temperature across the reaction space varies by less than 1.5 degrees Celsius.

24. A thermal system for a microfluidic substrate, the thermal system comprising a cooling fixture configured to reduce the temperature of the microfluidic substrate, the cooling fixture comprising a turbulent air flow cavity, a plurality of air flow diverters in the cavity, and an opening, wherein the microfluidic substrate extends across and covers the opening.

25. The thermal system of claim 24 further comprising: a heating fixture configured to raise the temperature of the microfluidic substrate, the heating fixture comprising an array of light emitting diodes configured to emit infra-red light incident on the microfluidic substrate; wherein the system is configured to cycle the temperature of the microfluidic substrate through a plurality of states including at least one cooled state and at least one heated state.

26. The thermal system of claim 25, wherein the microfluidic substrate has an area of at least 150 cm².

27. The thermal system of claim 26, wherein the cooling fixture further comprises an air inlet in fluid communication with the turbulent air flow cavity and an air exhaust in fluid communication with the turbulent air flow cavity, and wherein during operation of the cooling fixture cooled air enters the turbulent air flow cavity through the air inlet, flows in a turbulent fashion past the air diverters, and exhausts through the air exhaust.

28. The thermal system of claim 27, wherein cooled air is supplied to the turbulent air flow cavity by a vortex tube.

29. The thermal system of claim 25, wherein, when the microfluidic substrate is in the cooled state, the temperature across the microfluidic substrate varies by less than 2 degrees Celsius.

30. The thermal system of claim 25, wherein the array of light emitting diodes comprises a plurality of light emitting diodes configured to emit overlapping infra-red light beams incident on the microfluidic substrate.

31. The thermal system of claim 30, wherein the light emitting diodes of the plurality of light emitting diodes are spaced apart from one another and spaced away from the microfluidic substrate such that radiation profiles of adjacent light emitting diodes overlap.

32. The thermal system of claim 31, wherein, when the microfluidic substrate is in the heated state, the temperature across the microfluidic substrate varies by less than 2 degrees Celsius.

33. The thermal system of claim 24, wherein the microfluidic substrate is a flow cell comprising a first member and a second member spaced apart from the first member to define a fluidic passage between the first and second members, the flow cell defining an analyte reaction space in the fluidic passage.

34. The thermal system of claim 24, wherein the microfluidic substrate is an electrowetting substrate comprising an insulating layer and array of droplet manipulating electrodes.

35. A thermal cycling method comprising:
(a) positioning a flow cell between a heating fixture and a cooling fixture of a thermal system, wherein:
(i) the flow cell comprises a first member and a second member spaced apart from the first member to define a fluidic passage between the first and second members, the flow cell defining an analyte reaction space in the fluidic passage;
(ii) the heating fixture comprises an array of light emitting diodes configured to emit infra-red light incident on the second member of the flow cell;
(iii) the cooling fixture comprises a turbulent air flow cavity, a plurality of air flow diverters in the cavity, and an opening, wherein the first member of the flow cell extends across and covers the opening when the flow cell is positioned between the heating and cooling fixtures;
(b) flowing a reagent into the reaction space and operating the heating fixture to raise a temperature of the reaction space to a heated state;
(c) maintaining the heated state for an incubation period;
(d) after the incubation period, flowing another reagent into the reaction space and operating the cooling fixture to lower the temperature of the reaction space to a cooled state;
(e) repositioning the flow cell to an imaging station and imaging the flow cell;
(f) after imaging the flow cell, repositioning the flow cell between the heating and cooling fixtures.
